(19) United States
(12) Patent Application Publication
(10) Pub. No.: US 2008/0222370 A1
(43) Pub. Date: Sep. 11, 2008

(54) METHOD AND APPARATUS FOR DATA STREAM MANAGEMENT

(75) Inventors: Fitzgerald J Archibald, Bangalore (IN); Stephen Hsiao-Yi Li, Plano, TX (US); Michael O. Polley, Garland, TX (US); Mohamed F. Mansour, Richardson, TX (US); Ramesh Naidu G, Anantapur (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/045,267

(22) Filed: Mar. 10, 2008

Related U.S. Application Data
(60) Provisional application No. 60/893,907, filed on Mar. 9, 2007.

(51) Int. Cl. G06F 12/00

(52) U.S. Cl. 711/154; 711/E12.001

(57) ABSTRACT

A method and apparatus of managing data stream, the method comprising archiving received data in a circular buffer; utilizing a breakpoint in realizing the archived received data continuity, wherein the breakpoint is set to the last data portion of the archived received data; when the archiving of the received data approaches the end of the circular buffer, stitching the last portion of the archived received data to the start of the circular buffer; and setting the breakpoint to the updated last data portion of the archived data.

### CROSS-REFERENCE TO RELATED APPLICATIONS

This application claims benefit of U.S. provisional patent application Ser. No. 60/893,907, filed Mar. 9, 2007, which is herein incorporated by reference.

### BACKGROUND OF THE INVENTION

The present invention relates to a method and apparatus for data stream management.

Compressed media is packed into bitstream or bytestream by an encoder, which are serialized compressed data stream for broadcast or storage media. The decoder shall unpack the bitstream or bytestream, and perform necessary transformation of unpacked data using information available in unpacked data.

Compressed data is generally segmented as frames for error recovery, reducing decoding latency and buffering size. For example, In a MPEG 1 Layer 3 audio compression, the current frame can be decompressed using data from current and limited number of past frames. The past frame dependency is due to bit reservoir support in MPEG 1 Layer 3[3].

In order to decode the compressed audio streams, the bitstream or bytestram needs to be buffered in a memory accessible by decoder hardware. The decoder hardware shall perform bit/byte extraction from the stream buffer to retrieve information needed for decompression.

Since the rate of data stream and data processing is different, buffers are utilized to archive the data received and facilitate later processing of such data. Such processing requires a lot of data movement, processing cycles and power consumption.

Therefore, there is a need for a method and a system for improved data stream management.

### SUMMARY

Embodiment of the present invention is a method and apparatus of managing data stream. The method comprising archiving received data in a circular buffer; utilizing a breakpoint in realizing the archived received data continuity, wherein the breakpoint is set to the last data portion of the archived received data; when the archiving of the received data approaches the end of the circular buffer, stitching the last portion of the archived received data to the start of the circular buffer; and setting the breakpoint to the updated last data portion of the archived data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exemplary embodiment of a block diagram of a typical audio core;

FIG. 2 is an exemplary embodiment of a circular buffer utilizing bitstream breakpoint in accordance with the current invention;

FIG. 3 is an exemplary embodiment of utilizing a bit reservoir in accordance with the current invention;

FIG. 4 is an exemplary embodiment of a buffer 400 utilizing discontinuity break address in accordance with the current invention; and

FIG. 5 is an exemplary embodiment of a buffer utilizing odd byte address breakpoint handling in accordance with the current invention;

FIG. 6 is an exemplary embodiment of a buffer 600 utilizing odd byte address breakpoint handling and breakpoint word stitching in accordance with the current invention;

FIG. 7 is an exemplary embodiment of a buffer 700 utilizing odd byte address breakpoint handling in accordance with the current invention; and

FIG. 8 is an exemplary diagram illustrating of a buffer refill.

### DETAILED DESCRIPTION OF THE DRAWINGS

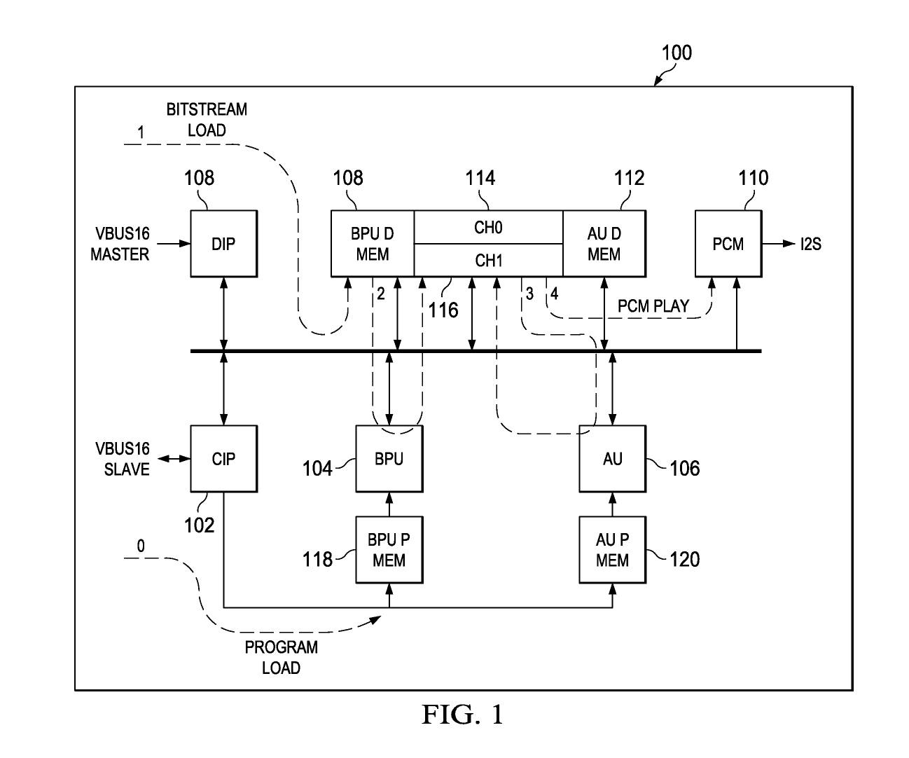

FIG. 1 is an exemplary embodiment of a block diagram of a typical audio core 100. The audio core 100 is initialized by a HOST (possibly an ARM core) through Control Input Port (CIP) 102. In this embodiment, the audio core 100 processes bitstreams. Bitstream Processing Unit (BPU) 104 and Arithmetic Unit (AU) 106 are the processing modules of the audio core 100. Data Input Port (DIP) 108 is for fetching compressed audio into BPU data memory 108. PCM interface (I2S) 110 provides uncompressed linear PCM audio samples to DAC.

In one embodiment, CIP 102 passes control information needed for processing the bitstream from HOST to the audio core 100 (i.e. BPU 104). The audio core 100 may intimate HOST of bitstream properties, playback completion of stream, etc. The audio core 100 may utilize multiple channels, such as, channel 0 (CH0) 114 and channel 1 (CH1) 116. The audio core 100 may utilize burst data transfer capability for allowing for faster data transfer.

BPU program memory 118 and AU program memory 120, usually, are separate program memories. Program memories may be entirely ROM, partly ROM and rest RAM, or entirely RAM. BPU data memory 108 and AU data memory 112 may be mix of RAM and ROM or RAM only. BPU 104 and AU 106 may communicate via a shared memory bank. In one embodiment, BPU 104 serves as master and AU 106 as slave. As such, BPU 104 may initiate AU to start executing instruction from AU program memory 102 and AU 106 may interrupt BPU 104 to inform AU of processing completion. BPU 104 and AU 106 may be idled (sleep) when not in use.

Bitstream buffer may be a 16 bit memory. During the unpacking of the bitstream, varying number of bits need to be extracted from the bitstream. The number of bits extracted need not fall on 16 bit (word) boundary. Thus, a ‘bit’ register is used to point to a current position on the bitstream, from which the next unpacking of bits needs to be performed (i.e. MS 12 bits of ‘bit’ hold word address and LS 4 bits hold bit position in the word). Furthermore, to extract bits, 16 bit funnel shifter may be used.

Usually, a bitstream contains more bits than available memory in a bitstream buffer. Thus, part of the bitstream is fetched into a bitstream buffer for decoding. A bitstream break interrupt may be set on any word boundary in the bitstream buffer. When a ‘bit’ pointer reaches the word breakpoint, breakpoint interrupt is generated. The bitstream break interrupt is usually utilized for handling the end of a bitstream buffer wrap-around and the main data discontinuity caused by the bit reservoir. Without bitstream break interrupt, the data usually needs to be stitched by means of extensive memory copy/move. Though this example describes the data as audio data, one of ordinary skill in the art would appreciate that the data may be any type of data, such as, media, video, and the like.

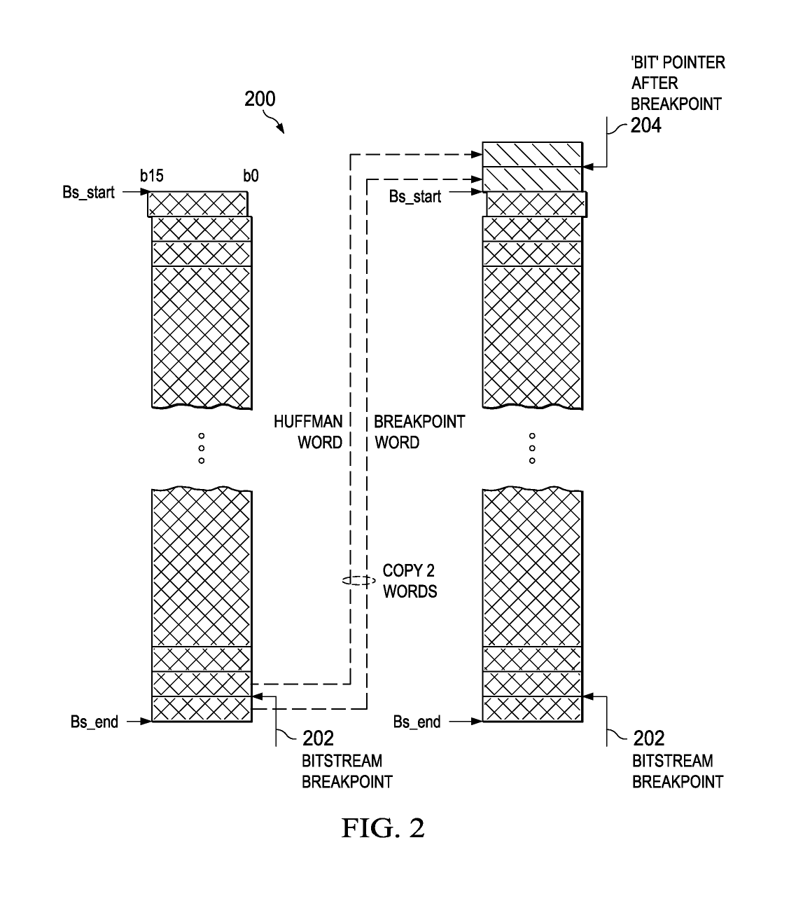

FIG. 2 is an exemplary embodiment of a circular buffer 200 utilizing bitstream breakpoint 202 in accordance with the current invention. In this embodiment, the bitstream buffer 200 is circular buffer in order to have continuity of bitstream data fetched into the bitstream buffer 200. Otherwise, the bitstream data remaining in the bitstream buffer 200 may have to be moved to start of the bitstream buffer before the bitstream (next part of) can be fetched from DIP. It is well know in the art that memory copy uses excess power and unwanted in managing bitstreams. A circular bitstream buffer 200 allows for contiguous data, unfixed frame length, and bitstream buffer 200 that is smaller than bitstream. Therefore, a circular bitstream buffer 200 requires less bitstream management and, thus, uses less power.

A circular buffering can be implemented using the bitstream breakpoint 202. FIG. 2 illustrates the use of bitstream breakpoint 202 to realize circular bitstream buffering. The bitstream breakpoint 202 is set on last word of the bitstream buffer. When ‘bit’ pointer reaches within last 1-16 bits in the buffer, following the previous bit extraction, breakpoint interrupt is generated. Thus, the last word is either partially consumed or fully available for the next bit extraction (when the breakpoint interrupt is serviced). Using memory copy, the last word in the bitstream buffer is stitched to the start of the bitstream buffer 200. The ‘bit’ pointer 204 is also updated to point to this word for next bit extraction instruction. When the wrap-around happens, the data before the end is consumed and, hence, may be refilled with next bitstream packet. Thus, data continuity is established with wrap-around.

One of ordinary skill in the art may recognize that a Huffman decoder, i.e. in MPEG 1 Layer 3, could move ‘bit’ pointer backwards by up to 16 bits (1 word). Thus, in circular buffer wrap-around, an additional word may be copied in order to satisfy a Huffman decoder. The word, before the breakpoint word (last word in bitstream buffer), is copied to the top of bitstream buffer+breakpoint word stitch, as shown in FIG. 2.

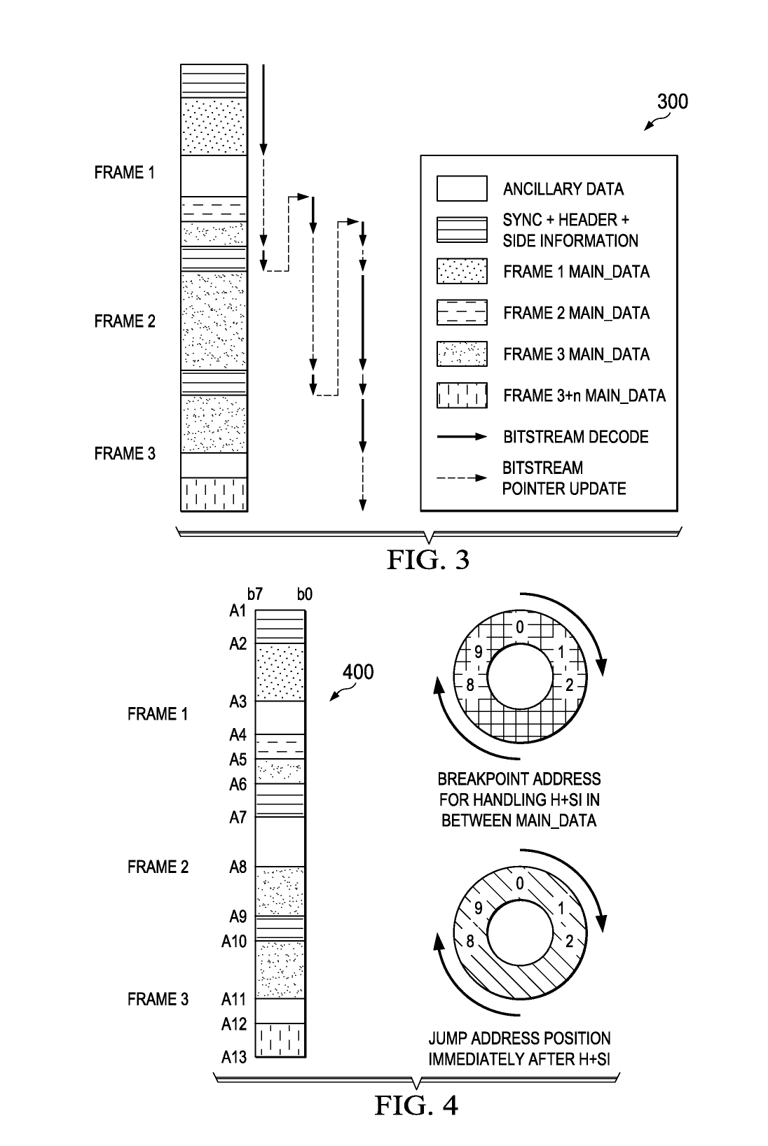

FIG. 3 is an exemplary embodiment of a buffer 300 utilizing a bit reservoir in accordance with the current invention. In order to have fixed frame length and varying amount of bits to encode a frame, bit reservoir may be used, i.e. in MPEG 1 Layer 3. The amount of bits used for encoding each frame depends on the audio content in the frame. Thus, if frame(s) use lesser bits than the maximum possible and successive frames need more bits, the successive frame data may be embedded in previous frames. A bit reservoir may be utilized to maintain constant bit rate and to provide more bits to frames that need more bits (i.e. if the previous frames had unused bits). For example, utilizing a bit reservoir, the main data of a frame can span over multiple frames (extending backwards/previous frames) limited by the beginning of the main data (main_data_begin) information in the bitstream. Note that the MPEG 1 Layer 3 states the maximum bitstream buffer required for decoder is 1 frame size of 320 kbps, 48 KHz stream.

FIG. 4 is an exemplary embodiment of a buffer 400 utilizing discontinuity break address in accordance with the current invention. The SYNC start address and SIDE INFORMATION end addresses of the last 10 frames are stored in the buffer 400. The buffer 400 may be circular; accordingly, in this embodiment, only one frame address will be inserted to the latest and the oldest deleted as decoder progresses 1 frame at a time. These addresses are used for 1) setting breakpoints to skip the non main_data part of data in the buffer during main_data parsing, in case of main_data spread across multiple frames; and 2) for detecting the actual start of main_data as the main_data_begin doesn't contain the “SYNC+Header+CRC+Side Information” size of the frames across which the main_data spreads. The SYNC position is used for setting up bitstream breakpoint. The end of H+SI position is used for repositioning ‘bit’ pointer.

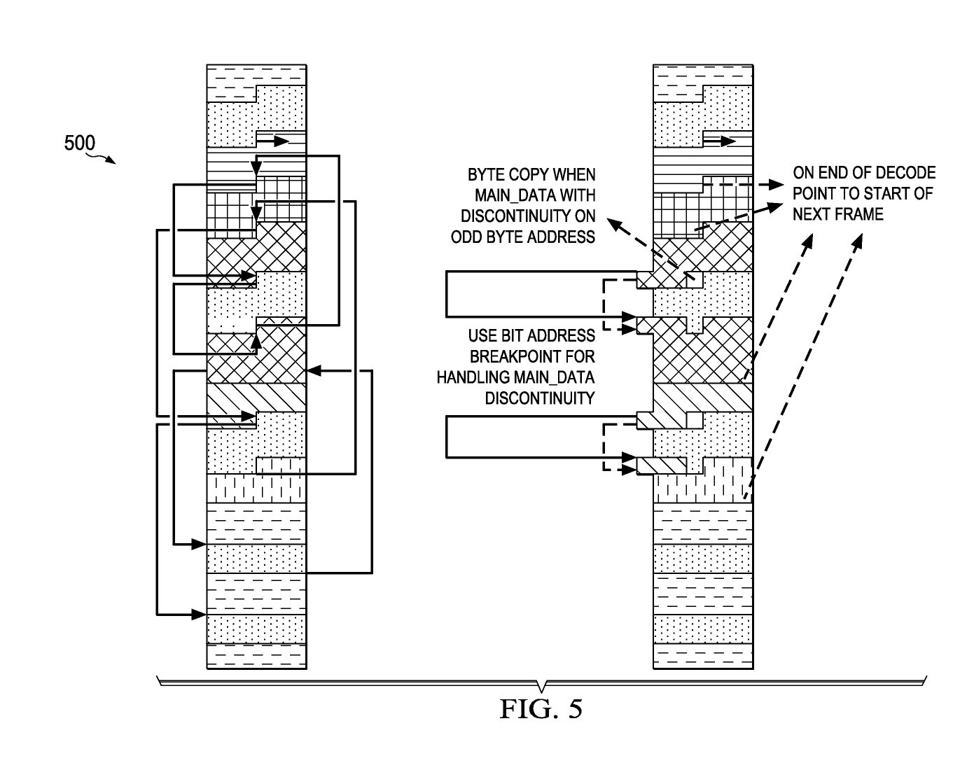

FIG. 5 is an exemplary embodiment of a buffer 500 utilizing odd byte address breakpoint handling in accordance with the current invention. In one embodiment, Mp3 data is byte aligned (sync, main_data start on byte boundary, Side information ends on byte boundary). Bitstream breakpoint is one word address (16 bit). So, any non-word aligned breakpoint is turned into word aligned breakpoint. This is done by moving/stitching the odd byte of data with the next set of data and setting breakpoint before this odd byte. In FIG. 5, the main_data of second frame is in previous frame and current frame. Both the sync start and side information end are on odd byte addresses. The odd byte before the sync word is copied just before the main_data continuation after side information end. The byte copy onto side information is acceptable since side information of current frame is already parsed and main_data of current frame will never extend beyond current frame end.

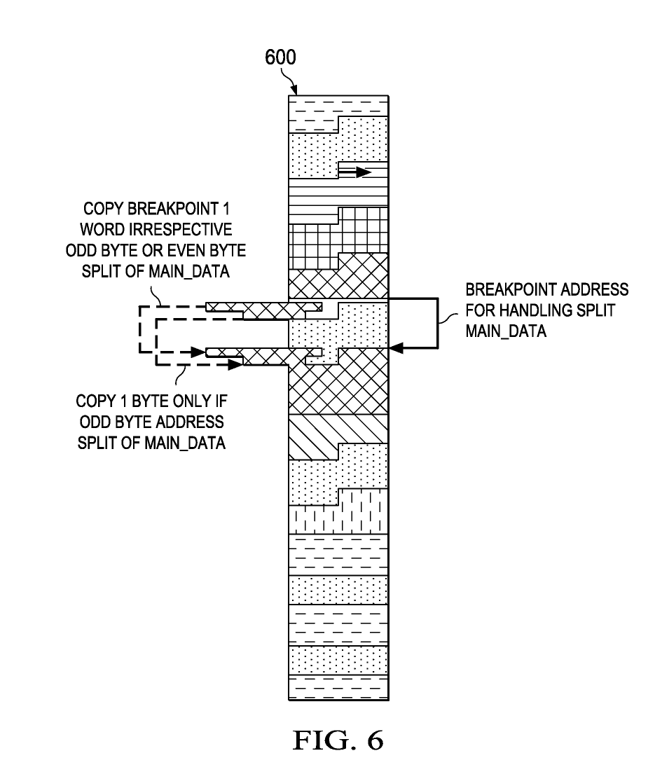

FIG. 6 is an exemplary embodiment of a buffer 600 utilizing odd byte address breakpoint handling and breakpoint word stitching in accordance with the current invention. The setting of breakpoint arise the need for copy of additional 1-word (breakpoint-word), as illustrated in FIG. 6 and explained previously.

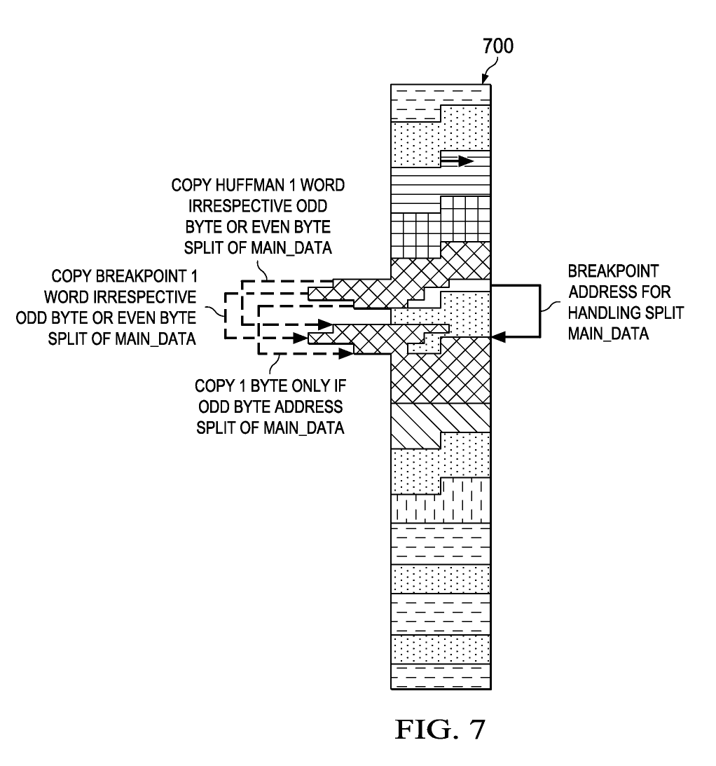

FIG. 7 is an exemplary embodiment of a buffer 700 utilizing odd byte address breakpoint handling in accordance with the current invention. Huffman decoder look back, as previously explained, need additional one word before the breakpoint word to be stitched as well. Thus, depending on whether odd byte is absent or present respectively, either 2 words or 2 words and a byte may be stitched, as shown in FIG. 7.

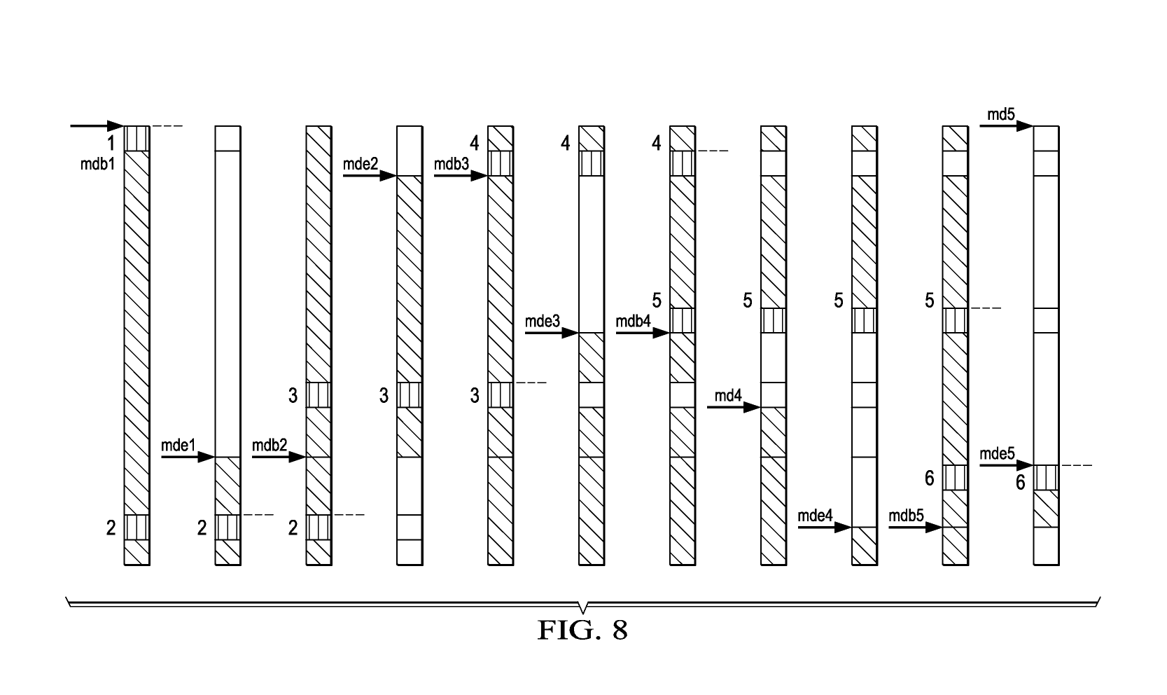

FIG. 8 is an exemplary diagram illustrating a buffer refill. As soon as a frame is decoded/parsed, the bits consumed can be refilled. In order to be able to decode mp3 streams using the least possible buffer size, the bitstream buffer may be refilled with respect refill start position, refill size, and the start time of refill. If the frame is self-contained, refill is as simple as fetch new data into lastly decoded frame area in the circular bitstream buffer. The refill end position in bitstream buffer can be determined from main_data_begin information contained in frame. The buffer position starting from the refill start position (past frame sync position) up to the refill end position (main_data begin position of current frame) may be refilled. The header and side information of the current frame would have already been parsed. By doing refill this way, it can be ensured (i.e. with a buffer size of 480 words) that the entire current frame, including the main_data of the current frame contained in previous frames, is available in the bitstream buffer for decoding.

If the refill area wraps around on bitstream buffer end, the refill be accompanied with two DMA transfers. The first transfer is to fill from refill start position through the end of bitstream buffer. The second transfer is to fill from bitstream buffer start through the refill end position.

For bit rates other than free format, frame length may be determined from bit rate and sample rate information contained in header. As such, the ‘bit’ pointer may be advanced by frame length from current frame sync position to obtain the next sync position. Since sync word pattern is not unique, this ensures the detected sync is not pseudo-sync. Moreover, it is beneficial in checking the header to detect stream consistency. In other words, header can be assumed as extension to sync word. The size of header, including extraneous information, may be a fixed number of bits. Furthermore, the main_data_begin may be included with the extraneous information. Thus, the entire current frame (including main_data contained in previous frames), the next frame header and side information may be contained in the bitstream buffer.

The last frame decode would not include a next frame sync. Hence, successive sync search logic may be skipped. If the file size of the stream being decoded is known, the last frame may be detected from DIP DMA source address; typically, the HOST would know the file size.

If next frame sync is not detected in estimated buffer position, the ‘bit’ position may be advanced by 8-bits from the current sync position and the sync search may be performed again. If a stream starts with non-mp3 data followed by mp3 bitstream, on detection of first sync, the buffer is refilled through the sync position. Once the sync position is filled, a full frame would be in the buffer. If the sync position is not found, the entire buffer would be refilled. After the refilling of the buffer, a sync search may be performed. If the sync is not found, other than for the last frame, the frame may be determined to be erroneous and not decoded.

In case of non-mp3 data in between mp3 data, the handling is similar to non-mp3 data in the beginning. The mp3 data marks the beginning of the decoding. The mp3 frame receding non-mp3 data is skipped from the decoder. Sync search is performed on the available data. Once the sync is detected, the buffer is refilled through the sync position. The refill may start from the bitstream buffer start. After the refill is performed, the decoding may continue normally.

If a main_data_begin field points to an invalid data, the frame is not decoded. In such a circumstance and since the buffer is circular, the main_data_begin may be pointing to future data. If the stream starts with non-zero main_data_begin (i.e. the frame refers to previous frame for current frame decode), and since a circular buffer wraps around the bitstream buffer start, the ‘bit’ pointer may look at future data for main_data decode/parse. As a result, the current frame is neither decoded nor refilled.

The next stream header and side information is parsed. The main_data_begin pointing position validity is established before proceeding to the decoding step. Since the previous frames are not present in memory, the data is not decoded. Consequently, and since the data is established as mp3 frames, the refill is not performed on non-decodable frames. As a result, only partial frame or full frame (not the next frame start) is present in bitstream buffer. If the next sync is not detectable in the bitstream buffer, the buffer is refilled to the side information of the next frame. This ensures the presence of the present frame in bitstream buffer, including main_data in past frames.

The DMA refill operation may run in parallel with decoding of the last granule/channel in current frame in AU. While the current frame PCM samples are being generated, the DMA refill operation requires the parsing of the side information (main_data_begin) of next frame. This is possible because of dual core architecture. The side information needed for the AU for processing PCM samples are already copied on the AU memory. Hence, the BPU can update the BPU memory with the next frame side information.

While the foregoing is directed to embodiments of the present invention, other and further embodiments of the invention may be devised without departing from the basic scope thereof, and the scope thereof is determined by the claims that follow.

What is claimed is:

1. A method of managing data stream, comprising:
archiving received data in a circular buffer;
utilizing a breakpoint in realizing the archived received data continuity, wherein the breakpoint is set to the last data portion of the archived received data;
when the archiving of the received data approaches the end of the circular buffer, stitching the last portion of the archived received data to the start of the circular buffer; and
setting the breakpoint to the updated last data portion of the archived data.

2. The method of claim 1, wherein the last data portion is the last word.

3. The method of claim 1, wherein an additional word is archived before the stitching of the last portion to account for a decoder.

4. The method of claim 3, wherein the decoder is at least one of a Huffman decoder or any decoder that refers to previously parsed decoded data.

5. The method of claim 1, wherein the stitching of the last portion handles the odd byte and word look back, when addressing is 16-bit words and data is discontinuous.

6. The method of claim 1, wherein the breakpoint is a hardware breakpoint.

7. The method of claim 1 further comprising refilling the circular buffer for holding a full frame, a next frame, and extraneous information.

8. The method of claim 1 further comprising fetching the next received data utilizing a DMA and simultaneously decoding the current received data.

9. The method of claim 8, wherein the received data is a frame of media data.

10. The method of claim 1 further comprising unpacking data utilizing bit addressing and bit extraction hardware.

11. A computer readable medium having instructions stored thereon that, when executed by a processor, causes the processor to perform a method of managing data stream, the method comprising:
archiving received data in a circular buffer;
utilizing a breakpoint in realizing the archived received data continuity, wherein the breakpoint is set to the last data portion of the archived received data;
when the archiving of the received data approaches the end of the circular buffer, stitching the last portion of the archived received data to the start of the circular buffer; and
setting the breakpoint to the updated last data portion of the archived data.

12. The computer readable medium of claim 11, wherein the last data portion is the last word.

13. The computer readable medium of claim 11, wherein an additional word is archived before the stitching of the last portion to account for a decoder.

14. The computer readable medium of claim 13, wherein the decoder is at least one of a Huffman decoder or any decoder that refers to previously parsed decoded data.

15. The computer readable medium of claim 11, wherein the stitching of the last portion handles the odd byte and word look back.

16. The computer readable medium of claim 11, wherein the breakpoint is a hardware breakpoint.

17. The computer readable medium of claim 11 further comprising refilling the circular buffer for holding a full frame, a next frame, and extraneous information.

18. The computer readable medium of claim 11 further comprising fetching the next received data utilizing a DMA and simultaneously decoding the current received data.

19. The computer readable medium of claim 18, wherein the received data is a frame of media data.

20. The computer readable medium of claim 11 further comprising unpacking data utilizing bit addressing and bit extraction hardware.

21. An apparatus for managing data stream, comprising:
means for archiving received streaming data in a circular buffer;
means for utilizing the breakpoint in realizing the archived received data continuity, wherein the breakpoint is set to the last data portion of the archived received data;
when the archiving of the received data approaches the end of the circular buffer, means for stitching the last portion of the archived received data to the start of the circular buffer; and
means for setting the breakpoint to the updated last data portion of the archived data.
